(19) United States
(12) Patent Application Publication
(10) Pub. No.: US 2008/0192058 A1
(43) Pub. Date: Aug. 14, 2008

(54) Scene Generating Method and System of Mobile Game

(76) Inventors: Qian Liu, Guangdong Province (CN); Qian Sun, Guangdong Province (CN); Jingmin Jiao, Guangdong Province (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/915,254

(22) PCT Filed: May 19, 2006
(86) PCT No.: PCT/CN2006/001042

§ 371 Date: Nov. 21, 2007

(30) Foreign Application Priority Data
May 21, 2005 (CN) 200510071570.0

(51) Int. Cl. G06F 17/00

(52) U.S. Cl. 345/473

(57) ABSTRACT

A scene generating method and system of mobile game. The scene generating method of mobile game generates scenes by the scene generating system of mobile game; the system includes at least a scene designing module and a scene storage module. The scene generating method of mobile game includes: setting primitive record in the scene storage module, getting primitive record from the scene storage module to assemble into a scene, converting the assembled scene into scene data corresponding to the scene, and storing the scene data into the scene storage module.

### FIELD OF THE INVENTION

The present invention relates to the technologies for generating game data, in particular, to a method and a system for generating a mobile game scene.

### BACKGROUND OF THE INVENTION

Mobile game is an electronic game service such as mobile phone chess and poker game, sports game, adventure game, pet game and so on, which is operated by a user on a platform, for example, a mobile terminal such as a mobile phone, a PDA (Personal Digital Assistant) and so on, via a mobile communication network.

With the development of mobile communication service, mobile phone game becomes spotlight which gains more and more attention. As a result, mobile device manufacturers and operators are carrying out a deeper research on the service, demand, technology and standard of mobile games.

One function of wireless network is similar to that of “virtual hard disk”. 3G network has a higher data transmission rate and powerful functions, so that users may be able to download larger and more attractive games and other applications. Because mobile game has the features of portability, easiness, network relevance, potential huge user group, etc, it has been developing rapidly in recent years, and it has become one of the main applications of 3G provided for commercial use. As a result, mobile games have become the focus of IT industry. As the types of mobile games become richer and the functions become more powerful, the function of online game is realized. In other words, one user may play a game with other uses by networking at any time and in any place. Moreover, because rich and colorful game maps (i.e. graphical game interface) can be provided, the mobile games may be more lively and vivid.

The main user groups of mobile games are youngsters. To attract these young game users, the game operators need to put forth new ideas constantly and increase the attraction of the game. However, the cost to develop a totally new game is very high and the development period is very long, so it is usually difficult to attain the expected objects. Therefore, the game operators usually try to improve the freshness and attraction of the game by constantly updating the game map of the game. Because the game map consists of at least one scene, and during the generation or update of the game map in the prior art it usually takes scene as one unit, it has the following disadvantages.

Because a scene is an integrated picture with a large volume of information, the time needed by a mobile game client to download the scene is long and a large storage space is needed to save the scene, but the storage space of a mobile terminal is limited and it is difficult for practical application.

Furthermore, the mobile game server and the client need to update the whole scene even if only a small part of the scene is changed, thus the working efficiency is lowered and non-beneficial cost is increased.

### SUMMARY OF THE INVENTION

In view of the above fact, the present invention provides a method for generating a mobile game scene. As a result, the scene data of the mobile game is made to be more concise, the volume of the scene data to be stored and transferred lower, the update of the scene much easier, more flexible and effective, and the cost lower.

The present invention further provides a system for generating a mobile game scene. As a result, the scene data of the mobile game is made to be more concise, the volume of the scene data to be stored and transferred lower, the update of the scene much easier, and the cost lower.

To attain the above objects, the present invention provides a method for generating a mobile game scene, which involves a system for generating a mobile game scene that comprises a scene design module and a scene storage module. The method for generating a mobile game scene comprises:

setting a graphic element record in the scene storage module;

obtaining the graphic element record from the scene storage module to assemble a scene; and

converting the assembled scene into scene data corresponding to the scene and storing the scene data in the scene storage module.

The step of setting the graphic element record comprises increasing, deleting or modifying the graphic element record, and the graphic element record comprises graphic element ID and graphic element display image data.

The graphic element record comprises basic graphic element record and expanded graphic element record, wherein the expanded graphic element consists of at least two basic graphic elements, and at least an expanded graphic element ID, the corresponding basic graphic element ID and location information are set in the expanded graphic element record.

The step of obtaining the graphic element record to assemble a scene further comprises:

obtaining the graphic element record from the scene storage module;

generating a building record from the obtained graphic element record, wherein a building ID and a building display image ID are set in the building record, and the building display image ID corresponds to the graphic element ID in the graphic element record; and

assembling the generated building record into a scene.

When the scene is assembled, the existing scene data and the obtained graphic element record are used together to generate the required scene.

The converted scene data comprises graphic element record, building record and scene record, and a scene ID is set in the scene record, while the scene IDs of affiliated scenes and location information are set in the building record.

The scene data is stored in the scene storage module in file mode or database mode, and correspondingly, the scene storage module is a file system or a database system.

After the scene is assembled from the graphic element record, each scene is further divided into a plurality of scene blocks via two sets of parallel lines that are intercrossed; the converted scene data corresponds to at least one scene block record, and each scene block record comprises the location information of the corresponding scene and scene block.

Type information and parameter information are further set in the building record or the scene block record; after the scene is assembled from the graphic element record, the type corresponding to at least one building record or scene block record is further set as an active area in the scene, and the parameter corresponding to the at least one building record or the scene block record is set as the function ID of the corresponding application.

A plurality of scene design modules are set in the system for generating a mobile game scene, and each scene design module simultaneously obtains a graphic element record from the scene storage module to assemble a scene; all the assembled scenes are respectively converted into scene data and the converted scene data is stored to the scene storage module.

The scene storage module is independent of the mobile game server, and after the scene data is stored to the storage module, the scene data is updated to the mobile game server synchronously, and the mobile game client obtains the scene data from the mobile game server and generates a scene.

The necessary original scene data and the required original graphic element record are stored on the mobile game client.

If scene data and graphic element record corresponding to the scene data are stored on the mobile game client, the mobile game client generates a scene corresponding to the scene data directly.

If no scene data and original graphic element record corresponding to the scene data are stored on the mobile game client, it requests to download the required graphic element record from the mobile game server to the local client and then generate a scene corresponding to the scene data.

Before the scene is generated using the existing scene data and graphic element record, the mobile game server is queried to determine whether the scene data is of the latest version; if yes, it turns to the step of generating a scene, otherwise, the scene data and graphic element record of the latest version are downloaded from the mobile game server.

A scene update list is set on the mobile game server, which is adapted to record the latest time the mobile game server updates the scene and the scene ID; and a scene update log is set in the mobile game client, which is adapted to record the latest time the mobile game client updates the scene and the scene ID.

The invention further provides a system for generating a mobile game scene, which comprises:

a scene storage module for storing original graphic element record and generated scene data; and

a scene design module for obtaining the graphic element record from the scene storage module to assemble a scene, converting the assembled scene into scene data of the corresponding scene, and storing the scene data to the scene storage module.

The scene design module comprises a design interface and a scene converting module, wherein the design interface is adapted to obtain the graphic element record from the scene storage module to assemble a scene, and increase, delete or modify the graphic element record; and the scene converting module is adapted to convert the scene assembled by the design interface into scene data and storing the scene data to the scene storage module.

A plurality of scene design modules are set in the system, each scene design module is connected with the scene storage module. The plurality of scene design modules simultaneously obtain a graphic element record from the scene storage module to assemble a scene, convert all the assembled scenes into scene data respectively and store the scene data to the scene storage module.

The scene storage module is a file system or a database system, and the scene data is stored in file mode or database mode.

The scene storage module and the mobile game server are set separately, and after the scene design module stores the converted scene data to the scene storage module, the scene storage module updates the scene data to the mobile game server synchronously; and

a scene generation module is set on the mobile game client, which is used to obtain the scene data from the mobile game server and generate a scene.

As described above, in the invention, the scene data is generated by the system for generating a mobile game scene, so that the generation and update of the game map may be realized. Because the generation and update of game scene takes graphic element as the unit, it has the following advantages in comparison with the prior art.

1) Because the information volume of a graphic element is much lower than that of a scene, the mobile game client can download rapidly, so that the efficiency may be improved.

2) The storage space used by the mobile game client to store the graphic element information is small, and for a scene consisting of repeated graphic elements, it only needs to store the graphic element ID and the location information, so that it may avoid to store scene pictures of large volume, thus resources may be saved.

3) When only part of the scene is changed, the mobile game server and the client only need to update one or more graphic elements, thus the update process may be easier, and more flexible and effective, and the cost may be lowered.

### BRIEF DESCRIPTION OF THE DRAWINGS

FIG. 1 is a block diagram illustrating an exemplary structure of the system for generating a mobile game scene according to the invention;

FIG. 2 is a flow chart of the method for generating a mobile game scene according to the invention;

FIG. 3 is a flow chart of the process for assembling a scene according to the invention;

FIG. 4 is a block diagram illustrating an exemplary structure of the system for generating a mobile game scene according to one embodiment of the invention;

FIG. 5 is a graph illustrating the flow path of the generated scene data according to the invention; and

FIG. 6 is a flow chart of the process for determining the scene version of the mobile game client according to one embodiment of the invention.

### DETAILED DESCRIPTION OF THE EMBODIMENTS

The above and other objects, features and advantages of the present invention will become apparent from the following description when taken in conjunction with the accompanying drawings which illustrate preferred embodiments of the present invention by way of example.

Referring to FIG. 1, it is a block diagram illustrating an exemplary structural of the system for generating a mobile game scene according to the invention. The system comprises a scene design module 110 and a scene storage module 120, wherein the scene design module 110 comprises a design interface 111 and a scene converting module 112.

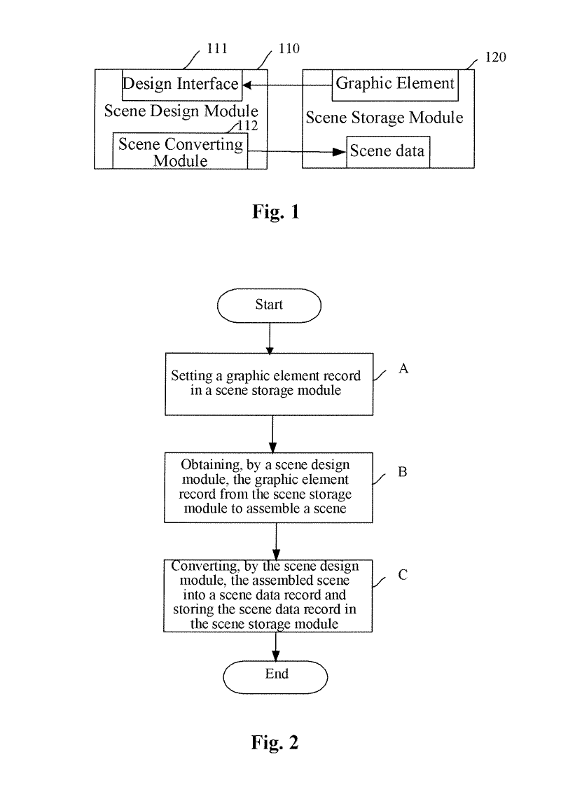

Referring to FIG. 2, the invention further provides a method for generating a mobile game scene, in which a scene is generated by using the above system for generating a mobile game scene. The method mainly comprises the following three steps.

Step A: A graphic element record is set in the scene storage module 120.

Step B: The scene design module 110 obtains the graphic element record from the scene storage module 120 to assemble a scene.

Step C: The scene design module 110 converts the assembled scene into a scene data record that corresponds to the scene uniquely, and stores the scene data record to the scene storage module 120.

The key point of the invention lies in the generation and update of a mobile game scene, which may be further assembled into a game map of a mobile game. In practice, game map data may specifically comprise four graph units: scene, building, scene block and graphic element. Each of these four graph units is explained as follows in detail.

Scene: A scene consists of various dynamic or static images, for example, geographic element images such as house, river, tree and so on, or decoration and property images such as desks and chairs, household appliances and so on. These images are arranged in a certain location sequence and form a game picture. Each game map may be divided into a plurality of scenes, and each scene is an independent downloadable unit and consists of at least one building, through which a game player may enter another scene. The game map data comprises a scene record, i.e. a SceneTab (Scene Table), which comprises information such as scene ID, scene name, scene description, terminal type and scene shape, for example, the SceneTab shown in Table 1.

TABLE 1
SceneTab

| Field Name | Type | Description |
|---|---|---|
| SceneID | digit | Scene ID |
| SceneName | string | scene name |
| SceneDesc | string | scene description |
| TerminalType | digit | terminal type |
| Width | digit | scene width |
| Height | digit | scene height |

Building: Building may be divided into functional building, decorative building and exit building. The functional building (such as game machine, supermarket and so on) corresponds to a certain mobile game or other related applications of the game system. For example, the mobile game may be a chess poker game and a mah-jong game, etc.; the other related applications may be a chat room program, a shopping and consuming program and a calculator, etc. The decorative building only plays a role of decorating the scene, such as the grassland, the tree and so on. The exit building acts as a passage for entering another scene from one scene, such as door. The game map data comprises a building record, i.e. CityBuildingTab, which comprises information such as building ID, building name, building location coordinate, building shape, advertisement location ID, building image layer attribute, affiliated scene ID of a building, building type, building parameter and the corresponding graphic element, for example, the CityBuildingTab shown in Table 2. The area where the building lies in is determined by the building location coordinate and shape information in CityBuildingTab; the building advertisement location ID may dynamically configure the advertisement information in the game map. Moreover, by setting the building image layer attribute of the building, a scene may be constructed according to the image layer attribute in the game map and a dynamic scenario may be displayed, such as the scenario in which a game role is masked by a graphic element.

TABLE 2
CityBuildingTab

| Field Name | Type | Description |
|---|---|---|
| BuildingID | digit | Building ID |
| BuildingName | string | Building Name |
| X | digit | X coordinate of the building in the scene |
| Y | digit | Y coordinate of the building in the scene |
| Width | digit | Width of the building |
| Height | digit | Height of the building |
| AdLocID | digit | The advertisement location ID if the building |
| | | has a advertisement location |
| Layer | digit | The layer where the building lies in, each scene |
| | | may be divided into a plurality of layers, and each |
| | | building can only belong to a specific layer. |
| SceneID | digit | The affiliated scene ID of the building |
| ParamType | digit | The type of an object represented by the building, |
| | | for being processed by the client |
| Param | string | The parameter to be input to realize the building |
| ElementID | digit | If a building consists of a basic graphic element, |
| | | the ID represents the basic graphic element ID |
| | | in the GraphicElementTab; if the building |
| | | consists of a plurality of basic graphic elements, |
| | | the ID represent the expanded graphic element ID |
| | | in the expanded graphic element table. |
| DestSceneID | digit | The ID of other scenes represented by the |
| | | building, if the building does not represent other |
| | | scenes, this value is meaningless. |
| DestBlockID | digit | If DestSceneID is meaningful, the ID represents |
| | | the location of a user after the user enters the |
| | | scene represented by DestSceneID |

Graphic element: A building combines one or more graphic elements. The graphic elements may be downloaded and stored in a mobile game client independently. The advantage of resolving a scene into buildings or graphic elements lies in that the information volume may be simpler than the case in which a scene consists of a complete picture, the time a mobile game client spends to download the scene may be shorter, and the storage space occupied may be less. Additionally, when a certain graphic element of a scene stored on the mobile game server is modified, the mobile game client may only need to update the graphic element synchronously, rather than update the whole scene, thus the download time may be saved, the scene may be expanded flexibly, and the cost may be lower.

Graphic element may be further divided into basic graphic element and expanded graphic element, the expanded graphic element consists of at least two basic graphic elements. A building in the building record corresponds to the basic graphic element ID or expanded graphic element ID so as to determine the display image of the building. The expanded graphic element is mainly used for easily editing the game map, wherein an expanded graphic element may be formed by combining several basic graphic elements. The expanded graphic element may be used as a whole; the mobile game client cannot feel the existence of the expanded graphic element, and the expanded graphic element record will not be sent to the mobile game client. A building consists of either a basic graphic element or an expanded graphic element.

The game map data comprises a basic graphic element record, i.e. GraphicElementTab (basic graphic element table). The GraphicElementTab comprises information such as basic graphic element ID, graphic element data (basic graphic element display image), and graphic element style and so on, for example, the GraphicElementTab shown in Table 3a.

TABLE 3a
GraphicElementTab

| Field Name | Type | Description |
|---|---|---|
| ElementID | digit | Basic graphic element ID |
| Element | binary | Graphic element data |
| Style | digit | Graphic element style, the scene of |
| | | each style can only use graphic |
| | | elements of the same style (cartoon |
| | | and classicality, etc.) |

The game map data may further comprise an expanded graphic element record, i.e. BuildingElementTab, which comprises information such as sequence number, expanded graphic element ID, basic graphic element ID, basic graphic element location, and basic graphic element serial number and so on, for example, the BuildingElementTab shown in Table 3b.

TABLE 3b
BuildingElementTab

| Field Name | Type | Description |
|---|---|---|
| SNO | digit | Sequence number, which is the master key of |
| | | the table, mainly for representing a record |
| | | uniquely |
| BuildingElementID | digit | ID of the expanded graphic element, if the |
| | | expanded graphic element consists of three |
| | | basic graphic elements, the expanded graphic |
| | | element ID for each of the three basic |
| | | graphic elements are the same |
| ElementID | digit | ID of the basic graphic element, which |
| | | represents the ID of the basic graphic |
| | | element that consists the expanded |
| | | graphic element |
| OffsetX | digit | X coordinate offset of the basic graphic |
| | | element in the expanded graphic element, |
| | | and the top left corner of the expanded |
| | | graphic element is the coordinate origin, |
| | | mainly used for drawing a basic graphic |
| | | element when the mobile game |
| | | client generates an expanded graphic element |
| OffsetY | digit | Y coordinate offset |
| Loc | digit | The serial number of the basic graphic |
| | | element in the expanded graphic element, |
| | | which is used for the mobile game |
| | | client to draw a picture, and |
| | | normal mask Relation between the basic |
| | | graphic elements in the expanded graphic |
| | | element may be guaranteed by drawing |
| | | according to the serial number |

Scene block: Each scene may be divided into a plurality of regular scene blocks. In this embodiment, two sets of parallel lines that are intercrossed are used to divide the scene, and each scene is divided into scene blocks of rectangle or common parallelogram, and the size of each scene block is totally the same. The main advantage of scene block lies in that it is convenient for the mobile game client to control the move of the game role on the mobile game client and to determine the shortest path along which the game role moves. The distance between the steps of the game role is a scene block. Scene block is divided into traversable scene block and untraversable scene block, wherein the untraversable scene block must be bypassed when the mobile game client controls the game role to move. Additionally, the visual angle of a graphical game map is usually 45 degrees, so the inclined angle between the two sets of parallel lines by which scene blocks are divided is preferably about 45 degrees. The game map data comprises a scene block record, i.e. SceneBlockTab, which comprises information such as scene block ID, affiliated scene ID, affiliated building ID, scene block type, scene block parameter and semantics of affiliated building, etc. for example, the SceneBlockTab shown in Table 4.

TABLE 4
SceneBlockTab

| Field Name | Type | Description |
|---|---|---|
| BlockID | digit | Scene block ID |
| SceneID | digit | Affiliated scene ID of the scene block |
| BuildingID | digit | Affiliated building ID of the scene |
| | | block, BuildingID is meaningful |
| | | only when Flag >= 3 and ≠ 11 |
| BlockType | digit | The type of the scene block, mainly |
| | | used for the process of the client |
| BlockParam | string | Parameter to be input to realize the |
| | | scene block |
| Flag | digit | Semantics of affiliated building of the |
| | | scene block |
| | | 1: traversable |
| | | 2: untraversable |
| | | 3: entrance |

The above four graphic elements are stored in the database record of the mobile game server. After a user subscribes for a game service successfully, the mobile game terminal may download the data packet for the mobile game client from a mobile game server or a dedicated download server, such as KJAVA download server, install and operate the mobile game client, and log on the mobile game server using an account and a password. After the authentication is passed, the initial game map picture is displayed, which may be contained in the downloaded data packet for the mobile game client, or may be downloaded from the mobile game server when the mobile game client is started. Moreover, when a graphic element in the mobile game server is updated, the mobile game server may send a message and query whether the mobile game client wants to update the graphic element, thus the mobile game server and the mobile game client may update the graphic element synchronously.

To better understand the invention, the steps of the method for generating a mobile game scene according to the invention will now be described in detail by referring to FIG. 1 and FIG. 2.

As shown in FIG. 2, in step A, a graphic element record is set in a scene storage module.

A graphic element record may be prestored and preset in the scene storage module 120. Alternatively, a graphic element record may be added, deleted or modified via the design interface 111 of the scene design module 110, and then the graphic element record that is added, deleted or modified is stored to the scene storage module 120.

The graphic element record may be divided into basic graphic element record and expanded graphic element record. For the contents of the basic graphic element record, reference may be made to the GraphicElementTab shown in Table 3a, and at least basic graphic element ID, basic graphic element display image and so on are set in the basic graphic element record. Moreover, the basic graphic element record further comprises at least one of the following: ElementName, Type, Style, TerminalType (such as mobile phone, PC, PDA and TV) and EIndex. The type of the basic graphic element may be divided into background, advertisement, building and expansion. Eindex is used for sorting the graphic elements of the same style and terminal type, from 1 to N, so that the processing speed of the mobile game client may be improved and the basic graphic element may be located directly according to the Eindex. The basic graphic element record may also comprise Count for the graphic element frame number and Duration for the refresh frequency, so that the mobile game client may playback the graphic element animation according to the Count and Duration.

Additionally, a plurality of basic graphic elements may be selected simultaneously, and a command of “Combine” may be executed by the design interface 111 of the scene design module 110, thus a plurality of basic graphic elements may be combined to form an expanded graphic element, which may be used as a whole. The expanded graphic element is mainly used for the design interface 111 to edit the scene more conveniently. The expanded graphic element record at least comprises expanded graphic element ID, the corresponding basic graphic element ID and location information of the basic graphic element, referring to the BuildingElementTab shown in Table 3b.

In step B, the scene design module obtains the graphic element record from the scene storage module to assemble a scene.

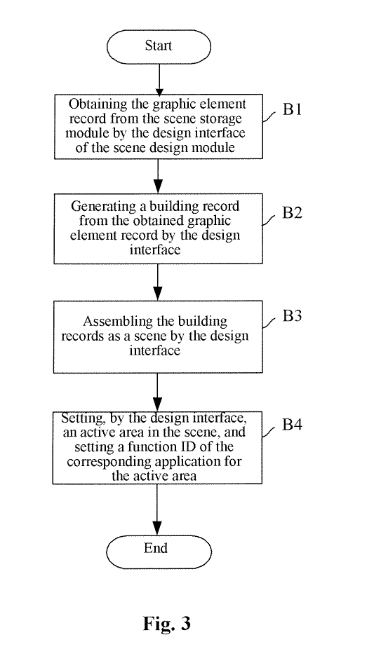

Referring to FIG. 3, step B may be further refined as the following steps.

As shown in FIG. 3, in step B1, the Design interface 111 of the scene design module 110 obtains the graphic element record from the scene storage module 120.

The scene storage module 120 may be a database system or a file system. In this embodiment, the scene storage module 120 is a database system. The design interface 111 of the scene design module 110 accesses the database system (i.e., the scene storage module 120) according to the configuration file. The design interface 111 may obtain the IP address, communication port, user information and so on of the database in which the graphic element record to be used is stored, so that the design interface 111 of the scene design module 110 may obtain the graphic element record. Of course, the graphic element record may be a basic graphic element record or an expanded graphic element record.

In step B2, the design interface 111 of the scene design module 110 generates a building record from the obtained graphic element record.

Actually, the design process on the graphic element record performed by the design interface 111 of the scene design module 110 is a process in which the graphic element is arranged and the attribute of each field is set. The design interface 111 sets a basic graphic element or an expanded graphic element as a building and sets a building record. The building, for example, is a game machine, a house and so on. The building record at least comprises information such as building ID, the corresponding graphic element and so on, and the building image is displayed via the corresponding graphic element display image. The building is taken as an entity element that consists of the scene directly, so that the scene may be expanded more flexibly.

In step B3, the design interface 111 of the scene design module 110 assembles several building records as a scene.

The design interface 111 of the scene design module 110 may assemble a scene by obtaining the graphic element record and the existing scene data in the scene storage module 120, and this method is adapted to update the existing scene. Alternatively, the design interface 111 of the scene design module 110 may only obtain the graphic element record in the scene storage module 120 so as to assemble a new scene, and this method is adapted to generate a totally new scene. After the design interface 111 of the scene design module 110 assembles the building record into a scene, it may further divide each scene via two sets of parallel lines into a plurality of scene blocks, such as rhombic scene blocks, and set a scene block record. Referring to the SceneBlockTab shown in Table 4, at least the corresponding scene and the location information of the scene block are set in each scene block record. As described above, the setting of the scene block makes it convenient for the mobile game client to control the game role to move and to determine the shortest path along which the game role moves.

In step B4, the design interface 111 of the scene design module 110 sets an active area in the scene, and sets a function ID of the corresponding application for the active area.

Referring to Table 2 and Table 4, the building record and the scene block record comprises type and parameter information. At least one building or scene block is selected in the scene by the design interface 111 as the active area, and the type of the building record or the scene block record is set as the active area, and the parameter corresponding to the building record or the scene block record is set as the function ID of the corresponding application. By setting an active area in the graphical game as the entrance of various mobile games or other related applications, the various mobile games and the graphical game maps do not need to be put together directly (which needs a large storage space), so that various mobile games or applications may be effectively invoked in the graphical game map under the existing mobile terminal device conditions.

Here, the invention will be illustrated in the case in which a building is set as the active area. Referring to Table 2, ParamType (building type) is recorded in the CityBuildingTab and the ParamType indicates the type of the object represented by the building. More critically, the building type indicates whether the building is an active area. In this embodiment, the building type further comprises:

1. Decorative Building;

2. Community Public Service;

3. Community Value-Added Service;

4. Game Classification;

5. Game Service;

6. Game Room (or Game Zone).

Referring to Table 2, building parameter (Param) is recorded in CityBuildingTab and represents the parameter that needs to be input to realize the corresponding function of the building, i.e. the function ID of the application corresponding to the building.

a) If the building type is decorative building, the building parameter is meaningless.

b) If the building type is community public service, the value of the building parameter may be the corresponding ID of functional applications, such as television, game machine, wardrobe, calculator, personal information, bulletin board, forum and so on, which are functions that will not be charged, i.e. free services.

c) If the building type is community value-added service, the building parameter is the service ID of the community value-added service, such as chat room application ID. Such a function will be charged, for example, it will be charged by the game server according to the recorded time a user uses the value-added service application, etc.

d) If the building type is game classification, the building parameter represents the specific game type, and the mobile game client displays the game list of the type.

e) If the building type is game service, the building parameter represents the specific game service ID, and the mobile game client may directly enter the game.

f) If the building type is game room or game zone, the building parameter represents the ID of a specific game room or game zone, and the mobile game client may directly enter the game room or the game zone.

Thus, it can be seen that except for decorative building, all the other building types may be active areas, so that several buildings may be selected and set in the game map data, the building types thereof may be set as active areas, and the building parameter may be set as the function ID of the corresponding application of the active area. Additionally, when an active area is set for the game map data of the mobile game client, it should be first checked whether an active area has already existed in a predetermined distance around the active area to be set. If yes, it is blocked to set the active area; otherwise, it is permitted to set the active area. Therefore, the error may be avoided that the game role starts two applications or mobile games simultaneously due to the short distance between the active areas.

In step C, the assembled scene is converted into scene data by the scene design module and stored to the scene storage module.

The scene converting module 112 of the scene design module 110 converts the scene assembled by the design interface 111 into scene data that corresponds to the scene uniquely, and stores the scene data to the scene storage module 120. At least a graphic element record, a building record and a scene record are set in the scene data, which will be illustrated referring to Table 1 to Table 4.

The graphic element record comprises graphic element ID, graphic element display image and so on; of course, the graphic element record comprises basic graphic element record and expanded graphic element record.

The building record comprises building ID, location coordinate, the corresponding graphic element ID and the scene ID that the building belongs to.

Scene record comprises scene ID and scene name.

The scene record and the building record are correlated via scene ID, and the building record and the graphic element record are correlated via the graphic element ID. Additionally, the scene data may be stored to the scene storage module 120 in a file mode or a database mode. Apparently, the scene storage module 120 may be a file system or a database system correspondingly. Here, the scene storage module 120 is a database system.

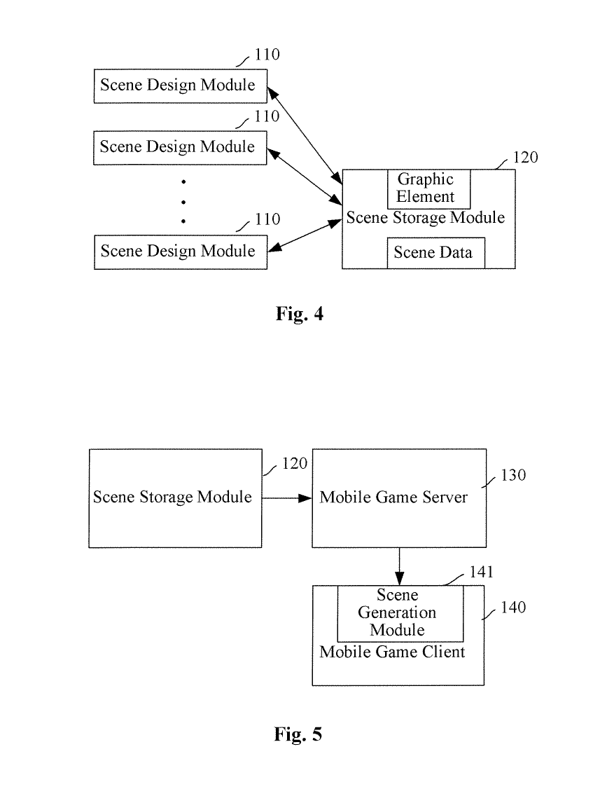

Referring to FIG. 4, it is a block diagram illustrating an exemplary structure of the system for generating a mobile game scene according to another embodiment of the invention. In this system, a plurality of scene design modules 110 are set, each scene design module 110 is connected with the scene storage module 120, and each scene design module 110 may simultaneously obtain the graphic element record from the scene storage module 120 to assemble a scene, and then convert all the scenes assembled into scene data respectively and store the scene data in the scene storage module 120. By employing such a system structure with a plurality of scene design modules, the scene may be designed by a plurality of developers simultaneously, so that the working efficiency may be improved.

Referring to FIG. 5, it shows a flow path of the generated scene data according to the invention. In the present invention, the scene storage module 120 is usually independent of the mobile game server 130, and the scene data is also stored on the mobile game server 130. Especially after the system for generating a mobile game scene designs the scene, the scene data will be updated to the mobile game server 130 synchronously. Moreover, after the scene converting module 112 of the scene design module 110 stores the scene data in the scene storage module 120 in step C, the scene storage module 120 updates the scene data to the mobile game server 130 synchronously. In addition, the scene generation module 141 is set in the mobile game client 140, wherein the scene generation module 141 is adapted to obtain the scene data on the mobile game server 130, obtain the location coordinate of the corresponding building in the corresponding building record and the graphic element data in the corresponding graphic element record, and generate a game scene according to the above graphic element data and building location coordinate.

The necessary original scene data and the original graphic element record to be used are usually stored in the mobile game client 140. Before the scene is generated, the mobile game client 140 performs the following steps according to the scene data obtained from the mobile game server 130.

Step D1: If the original scene data and the original graphic element record corresponding to the scene data are stored in the mobile game client, the mobile game client generates a scene corresponding to the scene data directly.

Step D2: If no original scene data and original graphic element record are stored in the mobile game client, the mobile game client requests to download the required graphic element record to the local client from the mobile game server, then generates a scene corresponding to the scene data.

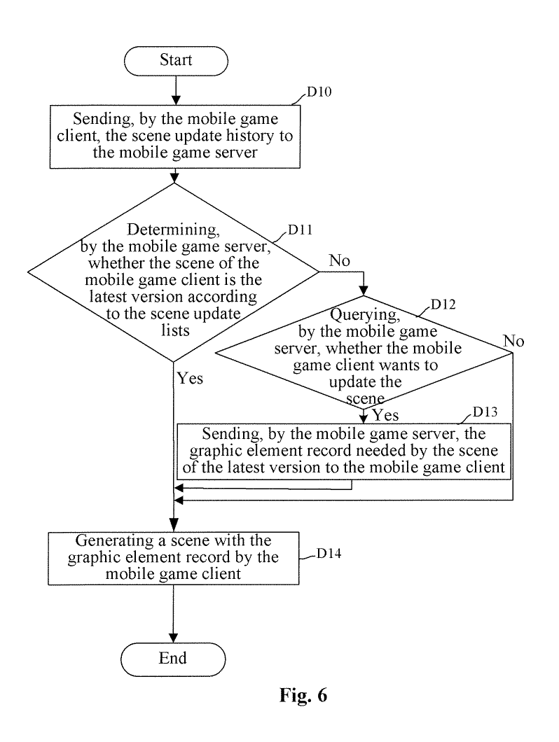

In the above step D1, before the scene is generated, it further comprises a step of determining the current scene version of the mobile game client. In this embodiment, a scene update list is set on the mobile game server 130, for recording the latest time the mobile game server 130 updates the scene and the scene ID; and a scene update log is set on the mobile game client 140, for recording the latest time the mobile game client 140 updates the scene and the scene ID. Referring to FIG. 6, the determination step is as follows.

Step D10: The latest time the scene is updated and the scene ID in the scene update log of the mobile game client is sent to the mobile game server.

Step D11: The mobile game server determines whether the original scene stored in the mobile game client is the latest version according to the latest time the scene is updated and the scene ID in the scene update list. If yes, proceeds to step D12; otherwise, proceeds to step D14.

Step D12: The mobile game server sends information to query whether the mobile game client wants to update the scene, if yes, proceeds to step D13; otherwise, proceeds to step D14.

Step D13: The mobile game server sends the graphic element record needed by the scene of the latest version to the mobile game client.

Step D14: The mobile game client uses the original graphic element record or the downloaded graphic element record to generate a scene.

In conclusion, because the generation and update of game scene takes graphic element as the unit in the invention, it has the following advantages.

Compared with the information volume of a scene, that of a graphic element is much lower, so the mobile game client can download rapidly with a higher efficiency. The storage space used by the mobile game client to store the graphic element information is small, and for a scene consisting of repeated graphic elements, it only needs to store the graphic element ID and the location information, so it may avoid storing scene pictures of large volume, and resources may be saved. When only part of the scene is changed, the mobile game server and the mobile game client only need to update one or more graphic elements, so that the update process may be easier, more flexible and effective, and the cost may be lowered. By taking a building consisting of one or more graphic elements as one entity element that consists of a scene directly, the scene may be expanded more flexibly, and the dynamic attribute of the scene may be improved by setting the building as an active area.

Additional advantages and modifications will readily occur to those skilled in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

1-19. (canceled)

20. A method for generating a mobile game scene, comprising:
setting a graphic element record;
obtaining the graphic element record to assemble a scene; and
converting the assembled scene into scene data corresponding to the scene and storing the scene data.

21. The method for generating a mobile game scene according to claim 20, wherein the graphic element record comprises graphic element ID and graphic element display image data.

22. The method for generating a mobile game scene according to claim 21, wherein the graphic element record comprises basic graphic element record and expanded graphic element record; the expanded graphic element consists of at least two basic graphic elements; and at least an expanded graphic element ID, the corresponding basic graphic element ID and location information are set in the expanded graphic element record.

23. The method for generating a mobile game scene according to claim 21, wherein obtaining the graphic element record to assemble a scene comprises:
obtaining the graphic element record;
generating a building record by the graphic element record, wherein a building ID and a building display image ID are set in the building record, and the building display image ID corresponds to the graphic element ID in the graphic element record; and
assembling the building record into the scene.

24. The method for generating a mobile game scene according to claim 20, wherein obtaining the graphic element record to assemble a scene comprises: existing scene data and the obtained graphic element record are used together to generate the required scene.

25. The method for generating a mobile game scene according to claim 23, wherein the converted scene data comprises the graphic element record, the building record and the scene record, and a scene ID is set in the scene record, while the scene IDs of affiliated scenes and location information are set in the building record.

26. The method for generating a mobile game scene according to claim 20, wherein the setting the graphic element record comprises increasing, deleting or modifying the graphic element record.

27. The method for generating a mobile game scene according to claim 20, wherein the scene is divided into a plurality of scene blocks; the converted scene data corresponds to at least one scene block record, and each scene block record comprises the location information of the corresponding scene and scene block.

28. The method for generating a mobile game scene according to claim 27, wherein the scene is divided into a plurality of scene blocks via two sets of parallel lines that are intercrossed.

29. The method for generating a mobile game scene according to claim 23, wherein type and parameter information are set in the building record; the type corresponding to at least one building record is further set as an active area in the scene, and the parameter corresponding to the at least one building record is set as the function ID of the corresponding application.

30. The method for generating a mobile game scene according to claim 27, wherein type and parameter information are set in the scene block record; the type corresponding to at least one scene block record is further set as an active area in the scene, and the parameter corresponding to the at least one scene block record is set as the function ID of the corresponding application.

31. The method for generating a mobile game scene according to claim 20, wherein the scene data is stored in a mobile game server and a mobile game client obtains the scene data from the mobile game server and generates a scene.

32. The method for generating a mobile game scene according to claim 31, wherein the basic original scene data and the required original graphic element record are stored on the mobile game client;
if the original scene data and the original graphic element record stored in the mobile game client are corresponding to the scene data obtained from the mobile game server, the mobile game client generates a scene corresponding to the obtained scene data; and
if the original scene data and the original graphic element record stored in the mobile game client are not corresponding to the scene data obtained from the mobile game server, the mobile game client requests to download the required graphic element record from the mobile game server and generates a scene corresponding to the scene data.

33. The method for generating a mobile game scene according to claim 31, further comprises, the mobile game server determines whether the original scene data in the mobile game client is the latest version, if yes, proceeds to the step of generating a scene; otherwise, the scene data and graphic element record of the latest version are downloaded from the mobile game server.

34. A system for generating a mobile game scene, comprising:
a scene storage module for storing original graphic element record and generated scene data; and
a scene design module for obtaining the graphic element record from the scene storage module to assemble a scene, converting the assembled scene into scene data of the corresponding scene, and storing the scene data to the scene storage module.

35. The system for generating a mobile game scene according to claim 34, wherein the scene design module comprises a design interface and a scene converting module, wherein the design interface is adapted to obtain the graphic element record from the scene storage module to assemble a scene, and increase, delete or modify the graphic element record; and the scene converting module is adapted to convert the scene assembled by the design interface into scene data and store the scene data to the scene storage module.

36. The system for generating a mobile game scene according to claim 34, wherein a plurality of scene design modules are set in the system, each scene design module is connected with the scene storage module, the plurality of scene design modules simultaneously obtain a graphic element record from the scene storage module to assemble a scene, convert the assembled scenes into scene data respectively and store the scene data to the scene storage module.

37. The system for generating a mobile game scene according to claim 34, wherein the scene storage module is a file system or a database system, and the scene data is stored in a file mode or a database mode.

38. The system for generating a mobile game scene according to claim 34, further comprises a mobile game server which is separate from the scene storage module;
wherein the scene storage module updates the converted scene data to the mobile game server synchronously.

39. The system for generating a mobile game scene according to claim 38, further comprises a mobile game client which is configured to obtain the scene data from the mobile game server and generate a scene.

40. The system for generating a mobile game scene according to claim 39, wherein the mobile game serve comprises a scene update list which is adapted to record the latest time the mobile game server updates the scene and the scene ID; and
wherein the mobile game client comprises a scene update log which is adapted to record the latest time the mobile game client updates the scene and the scene ID.

41. The system for generating a mobile game scene according to claim 39, wherein the mobile game client is configured to store the basic original scene data and the required original graphic element record;
if the original scene data and the original graphic element record stored in the mobile game client are corresponding to the scene data obtained from the mobile game server, the mobile game client generates a scene corresponding to the obtained scene data;
if the original scene data and the original graphic element record stored in the mobile game client are not corresponding to the scene data obtained from the mobile game server, the mobile game client requests to download the required graphic element record from the mobile game server and generates a scene corresponding to the scene data.

42. The system for generating a mobile game scene according to claim 39, wherein the mobile game client comprises a scene generation module which is configured to obtain the scene data from the mobile game server and generates a scene.
